(19) United States
(12) Patent Application Publication
(10) Pub. No.: US 2025/0217831 A1
(43) Pub. Date: Jul. 3, 2025

(54) COLLECTIVE HOUSING MARKET PRICE ESTIMATION SYSTEM AND METHOD HAVING SIMILAR COMPLEX GROUP GENERATION UNIT

(71) Applicant: KOREA REAL ESTATE BOARD, Daegu (KR)

(72) Inventors: Dae Whan KIM, Namyangju-si (KR); Jin Ho CHOI, Daegu (KR); Gwa Young PARK, Daegu (KR)

(21) Appl. No.: 17/768,990

(22) PCT Filed: Apr. 22, 2021
(86) PCT No.: PCT/KR2021/005066

§ 371 Date: Apr. 14, 2022

(30) Foreign Application Priority Data
May 22, 2020 (KR) 10-2020-0061359

(51) Int. Cl. G06Q 30/0201; G06Q 50/16

(52) U.S. Cl. CPC G06Q 30/0206; G06Q 50/16

(57) ABSTRACT

A collective housing market price estimation system includes: a database unit configured to collect and store officially announced price information, market price information, and housing characteristic information; a similar complex group generation unit configured to select real estate similar to a target house as a similar complex group by using the housing characteristic information of the database unit; a price information maintenance unit configured to remove a characteristic inconsistency case and a price outlier case from the information of the database unit regarding the similar complex group selected by the similar complex group generation unit; a similar case extraction unit configured to extract one or more cases similar to the target house from the similar complex group; and a final price calculation unit configured to estimate the price of the target house from the similar cases extracted by the similar case extraction unit.

### TECHNICAL FIELD

The present invention relates to a collective housing market price estimation system and method. More specifically, the present invention relates to a collective housing market price estimation system and method having a similar complex group generation unit.

### BACKGROUND ART

The government is implementing and operating various real estate policies to stabilize the real estate market, prevent speculation, and enhance housing welfare. The need for the estimation of market prices is increasing in order to diagnose the effects of real estate policies and understand regional situation changes.

In response to this, the present applicant proposed a ‘System and Method for Calculating Real Estate Market Prices Using a Homogeneous Land Price Area and Actual Transaction Prices’ in Korean Patent No. 10-1762888.

As real estate transaction reporting became mandatory and related information is accumulated, basic information for the estimation of real estate prices is prepared. However, due to false reports, the intervention of circumstances, and trading bias in terms of region and type, it is necessary to reorganize and supplement actual transaction information.

In particular, there is a problem in that the confidence of prices finally calculated based on inaccurately extracted similar cases is also degraded because the criteria for accurately extracting similar cases are not presented.

Furthermore, in the case of collective housing, the degree of similarity between individual complexes needs to be taken into consideration in order to extract similar cases. The prior art does not approach similar cases of collective housing in this manner.

### DISCLOSURE

### Technical Problem

A collective housing market price estimation system and method having a similar complex generation unit according to the present invention have the following technical problems:

First, the present invention intends to present conditions for the generation of a similar complex group in detail.

Second, the present invention intends to present priorities for the extraction of similar cases in detail.

Third, the present invention intends to be used for the verification of false sales in real transactions and the generation of trading price indices by estimating the market prices of nationwide collective housing according to objective criteria, thereby enabling market management, research, and statistics regarding real estate to be systematized and objectively performed.

Fourth, the present invention intends to be used for the support of various government policies, such as the designation of a speculative zone, the management of the pre-sale housing market, and the simulation of policy introduction.

The technical problems to be solved by the present invention are not limited to those mentioned above, and other problems not mentioned will be clearly understood by those skilled in the art from the following description.

### Technical Solution

The present invention is directed to a system that is operated by a program executed by an arithmetic processing means including a computer and estimates the market price of a collective house.

The collective housing market price estimation system having a similar complex group generation unit according to the present invention includes: a database unit configured to collect and store officially announced price information, market price information, and housing characteristic information; a similar complex group generation unit configured to select real estate similar to a target house as a similar complex group by using the housing characteristic information of the database unit; a price information maintenance unit configured to remove a characteristic inconsistency case and a price outlier case from the information of the database unit regarding the similar complex group selected by the similar complex group generation unit; a similar case extraction unit configured to extract one or more cases similar to the target house from the similar complex group; and a final price calculation unit configured to estimate the price of the target house from the similar cases extracted by the similar case extraction unit.

In the present invention, the collective housing may include at least one of apartment housing, tenement housing, and multi-household housing.

In the present invention, the market price information of the database unit may include at least one of transaction case prices, appraisal case prices, and regional survey case prices.

In the present invention, the housing characteristic information of the database unit may include at least one of location information, complex information, number-of-households information, floor information, exclusive area information, structure information, date-of-approval-for-use information, and land share information.

In the present invention, the similar complex group generation unit may select, as the similar complex group, a complex, whose aging condition, complex size condition, and distance condition satisfy preset ranges based on a complex to which the target house belongs, from the housing characteristic information.

The aging condition according to the present invention may be that the difference in a date of approval for use with respect to the complex to which the target house belongs is equal to or smaller than a preset reference.

The complex size condition according to the present invention may be that the difference in the total number of households with respect to the complex to which the target house belongs is equal to or smaller than a preset reference.

The distance condition according to the present invention may be that the separation distance from the complex to which the target house belongs is equal to or shorter than a preset reference.

The price information maintenance unit according to the present invention may include a characteristic inconsistency case removal unit configured to remove a case in which officially announced price information and housing characteristic information are different.

The price information maintenance unit according to the present invention may include a price outlier case removal unit configured to remove case information in which a realization rate, which is the ratio of the officially announced price of collective housing, corrected for the time when an actual transaction is performed by using an apartment housing transaction price index or a tenement/multi-householder housing transaction price index, to the actual transaction price of the collective housing, is outside a preset range:

$$Realization Rate = \frac{Temporally - corrected officially announced price}{Actual transaction price}$$

The similar case extraction unit according to the present invention may include an extraction condition application unit configured to apply conditions for extracting the similar cases from the market price information of the similar complex group, and a priority condition application unit configured to extract one or more cases similar to the target house from the cases, extracted by the extraction condition application unit, by applying priority conditions.

The extraction condition application unit according to the present invention may extract the one or more similar cases by sequentially applying: a first extraction condition for extracting market price information within a preset period; a second extraction condition for extracting information in which a difference in area with respect to the target house is within a preset range; and a third extraction condition for extracting only latest information when a plurality of pieces of market price information is present for the target house.

The priority condition application unit according to the present invention may extract the one or more similar cases by sequentially applying: a first priority condition for extracting a case of a same complex in preference to a case of a similar complex; a second priority condition for preferentially extracting a case whose case time point is within a preset period from a reference time point; and a third priority condition for preferentially extracting cases in a sequence of a case of a same area, a case of a same pyeong type, and a case of a similar area.

The final price calculation unit according to the present invention may include a per-complex average realization rate calculation unit configured to calculate the average realization rate of each complex by obtaining the arithmetic average of the realization rates of extracted case prices for each complex.

The final price calculation unit according to the present invention may include a per-case trial price calculation unit configured to calculate the trial price for each case by dividing a corresponding realization rate by the officially announced price of the target house.

The final price calculation according to the present invention may include a price determination unit configured to calculate a realization rate correction value by using the difference between the average realization rate of a complex to which the target house belongs and the average realization rate of a similar complex before calculating a final price.

The price determination unit according to the present invention may calculate the realization rate correction value as 1.000 when the difference between the average realization rates is equal to or smaller than a preset reference.

The price determination unit according to the present invention may calculate the realization rate correction value by the following equation:

$$Realization rate correction value = \frac{Average realization rate of target complex}{Average realization rate of similar complex}$$

when the difference between the average realization rates exceeds the preset reference.

The price determination unit according to the present invention may calculate a final trial price by weighting per-case trial prices with the reciprocal of a distance to the target complex and then averaging them through the following equation:

$$Final Trial Price = \frac{\frac{1}{d i s {t}_{1}} \times {price}_{1} + … + \frac{1}{d i s {t}_{5}} \times {price}_{5}}{\frac{1}{d i s {t}_{1}} + … + \frac{1}{d i s {t}_{5}}} \times temporal correction value$$

(where dist₁ and dist₅ are the straight-line distances between the target complex and cases 1 and 5, and price₁ and price₅ are ‘per-case trial prices’ of cases 1 and 5).

The final price calculation unit according to the present invention may include a confidence rating unit configured to assign a confidence level of any one of good, normal, and insufficient when the number of cases finally extracted is within a preset range.

The confidence rating unit according to the present invention may assign a confidence level lower than a reference level by one level when the number of per-case trial prices to which the realization rate correction value is applied is equal to or larger than a preset number.

The present invention is directed to a collective housing market price estimation method having a similar complex group generation unit, the collective housing market price estimation method being configured in the form of a program executed by an arithmetic processing means including a computer, the collective housing market price estimation method including: step S1 of collecting and storing, by a database unit, officially announced price information, market price information, and housing characteristic information; step S2 of selecting, by a similar complex group generation unit, real estate similar to a target house as a similar complex group by using the housing characteristic information of the database unit; step S3 of removing, by a price information maintenance unit, a characteristic inconsistency case and a price outlier case from the information of the database unit regarding the similar complex group selected by the similar complex group generation unit; step S4 of extracting, by a similar case extraction unit, one or more cases similar to the target house from the similar complex group; and step S5 of estimating, by a final price calculation unit, the price of the target house from the similar cases extracted by the similar case extraction unit.

The present invention may be implemented as a computer program stored in a computer-readable recording medium in order to perform the collective housing market price estimation method having a similar complex group generation unit according to the present invention in combination with hardware for processing information via software on a computer.

### Advantageous Effects

The collective housing market price estimation system and method having a similar complex generation unit according to the present invention have the following effects:

First, the present invention has an effect of generating a similar complex group by applying an aging condition, complex size condition, and distance condition for each complex.

Second, the present invention has an effect of extracting similar cases suitable for a target house for the estimation of a market price by being equipped with the extraction condition application unit and the priority condition application unit in order to extract similar cases.

Third, the present invention has an effect of generating general transaction indices and establishing transparent transaction order by providing fair market price references to the real estate market.

Fourth, the present invention has an effect of improving work efficiency and accuracy by using the system and the method for verification purposes when performing survey, statistics, and market management regarding real estate.

Fifth, the present invention has an effect of generating a virtuous cycle for system improvement through the improvement of the utilization of actual transaction information, the diagnosis of the appropriateness of transaction cases, etc.

The effects of the present invention are not limited to those mentioned above, and other effects not mentioned will be clearly understood by those skilled in the art from the following description.

### DESCRIPTION OF DRAWINGS

FIG. 1 shows the overall structure of a collective housing market price estimation system having a similar complex generation unit according to the present invention;

FIG. 2 shows the operation algorithm of a similar complex generation unit according to the present invention;

FIG. 3 shows the operation algorithm of a characteristic inconsistency case removal unit in a price information maintenance unit according to the present invention;

FIG. 4 shows the operation algorithm of a price outlier case removal unit in a price information maintenance unit according to the present invention;

FIG. 5 shows the operation algorithm of an extraction condition application unit in a similar case extraction unit according to the present invention;

FIG. 6 shows the operation algorithm of a priority condition application unit in a similar case extraction unit according to the present invention;

FIG. 7 shows the operation algorithm of a final price calculation unit according to the present invention; and

FIG. 8 is a comparison diagram comparing a collective housing market price estimation system according to the present invention and a case.

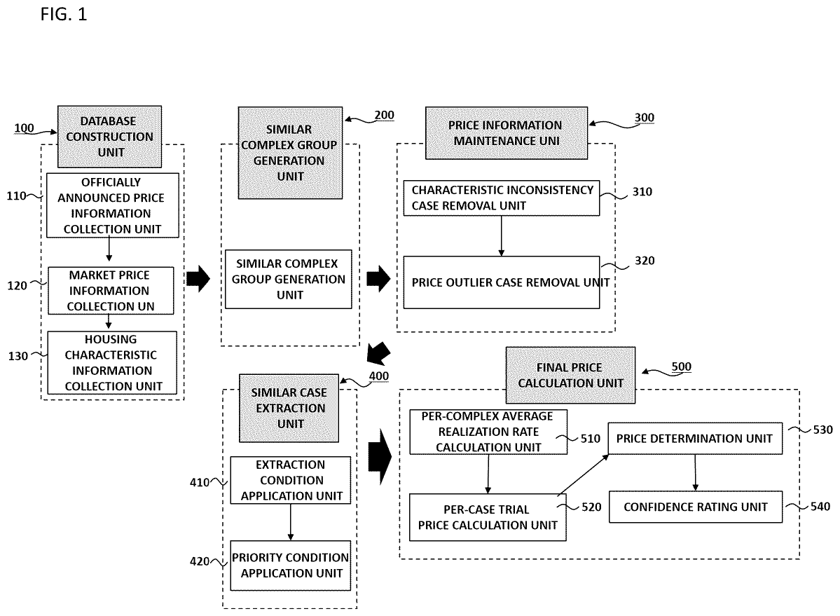

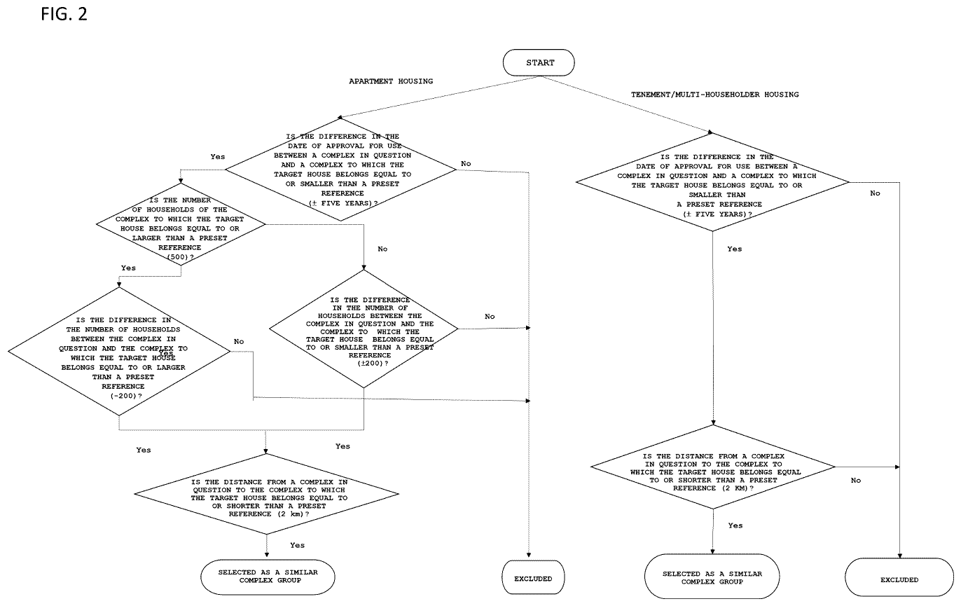

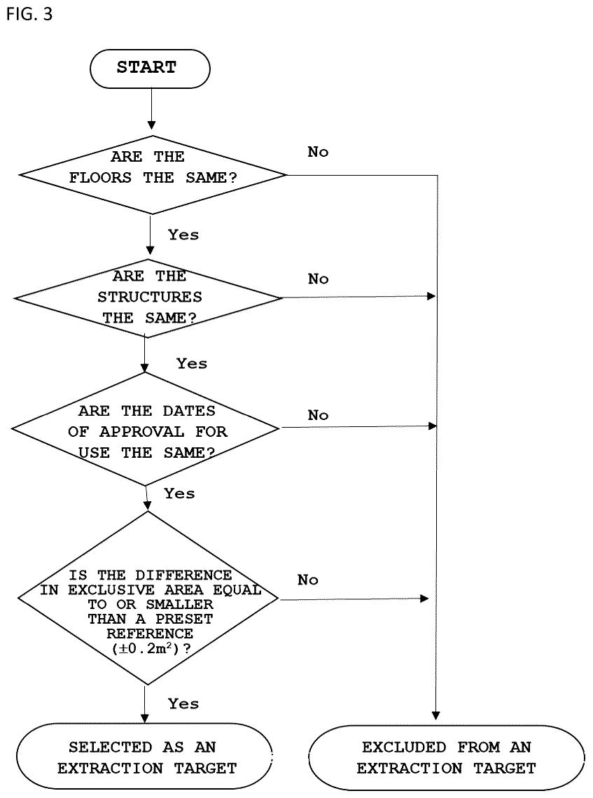

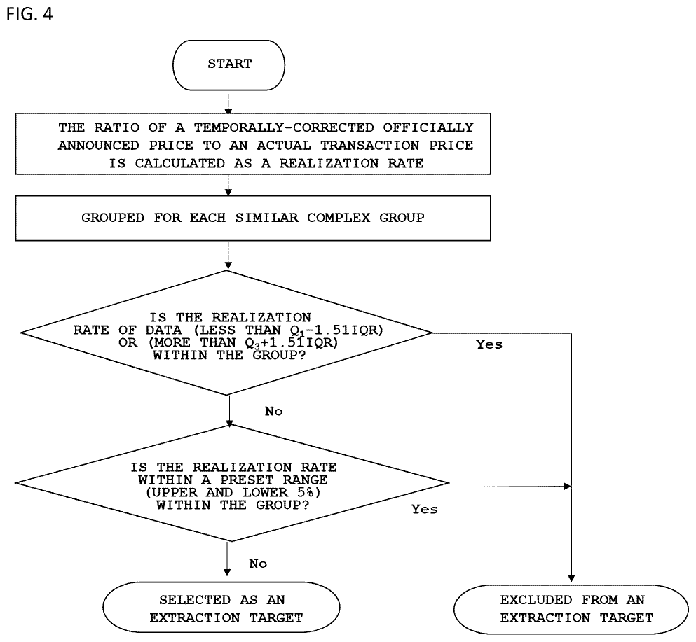

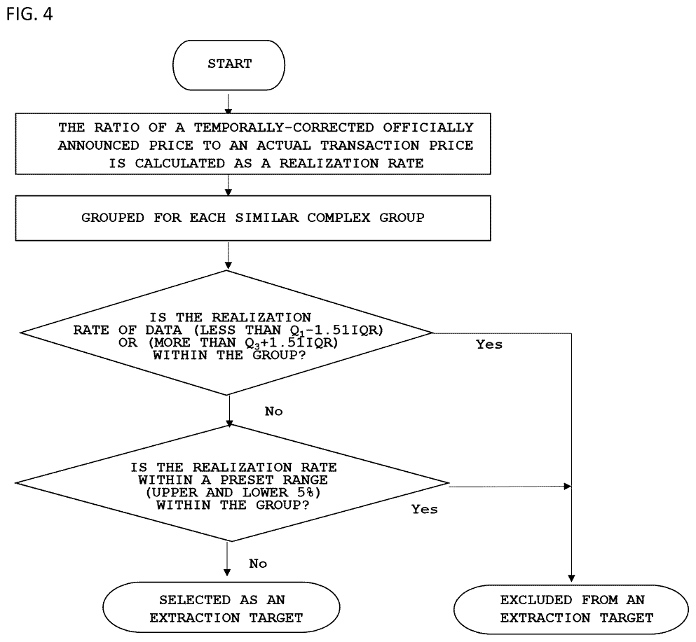

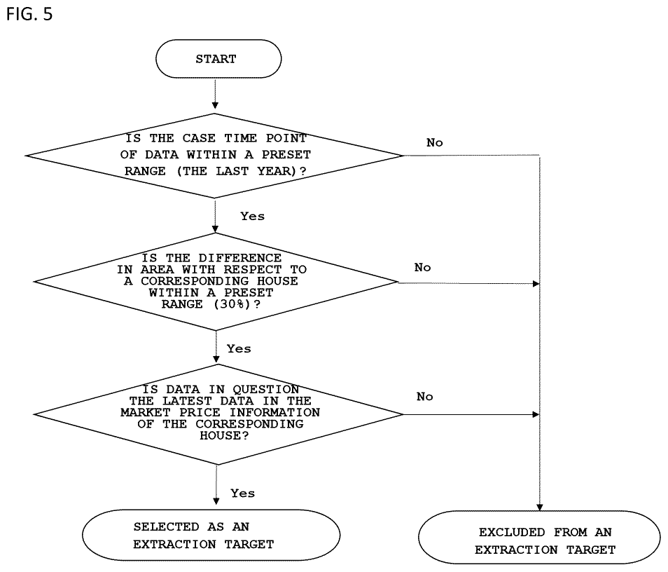

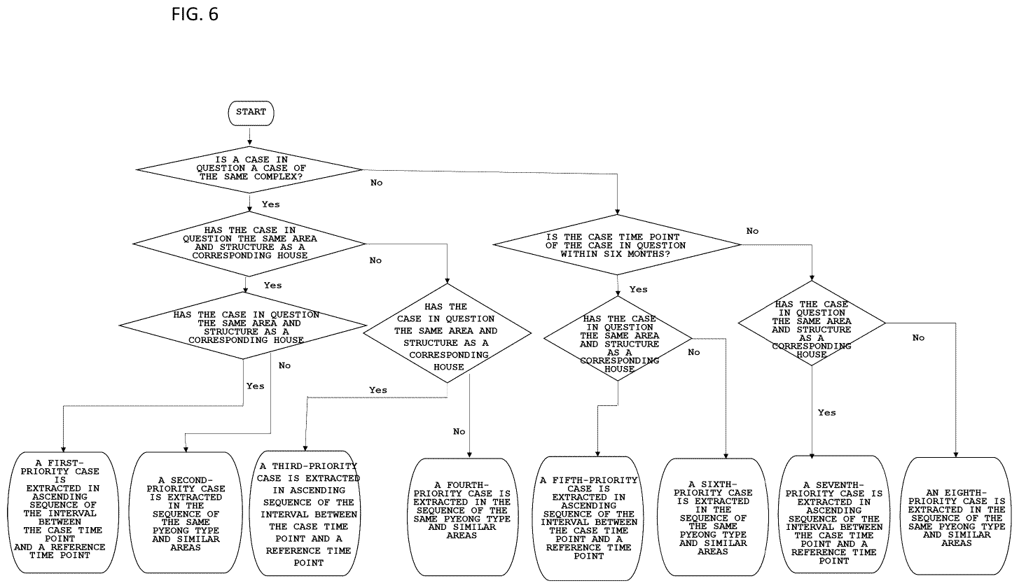

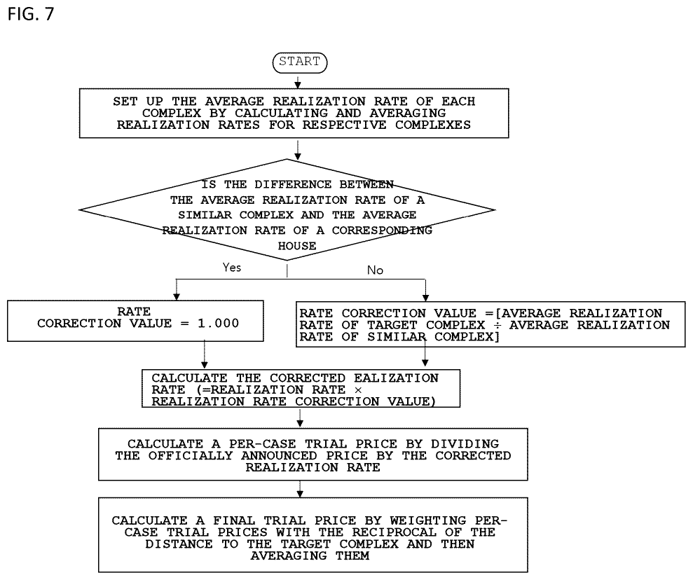

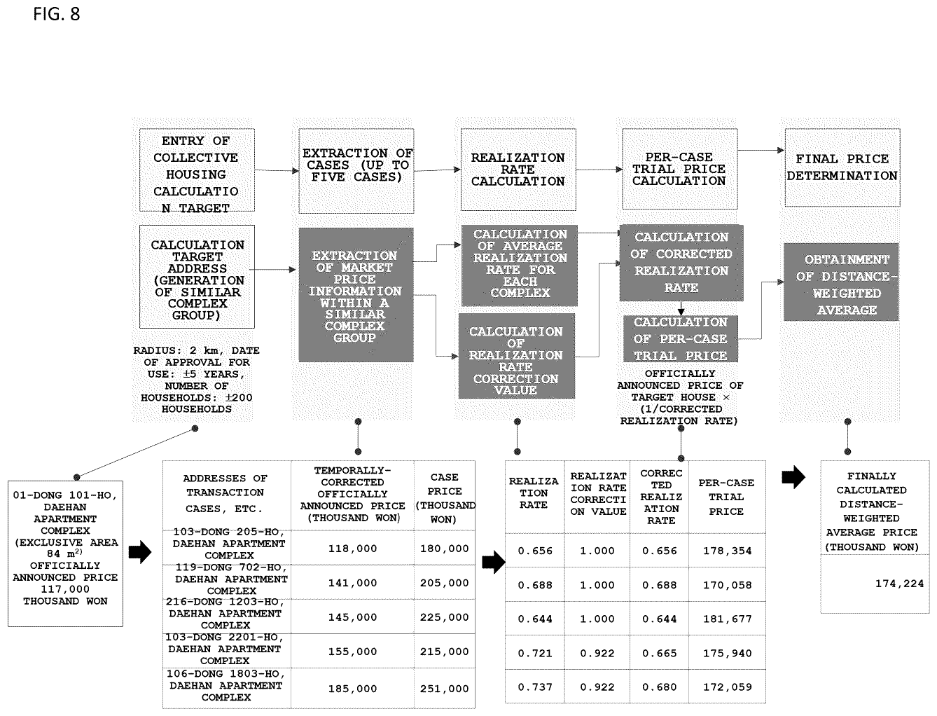

### BEST MODE

The present invention is directed to a system that is operated by a program executed by an arithmetic processing means including a computer and estimates the market price of a collective house.

The collective housing market price estimation system having a similar complex group generation unit according to the present invention includes: a database unit configured to collect and store officially announced price information, market price information, and housing characteristic information; a similar complex group generation unit configured to select real estate similar to a target house as a similar complex group by using the housing characteristic information of the database unit; a price information maintenance unit configured to remove a characteristic inconsistency case and a price outlier case from the information of the database unit regarding the similar complex group selected by the similar complex group generation unit; a similar case extraction unit configured to extract one or more cases similar to the target house from the similar complex group; and a final price calculation unit configured to estimate the price of the target house from the similar cases extracted by the similar case extraction unit.

### MODE FOR INVENTION

Embodiments of the present invention will be described below so that those of ordinary skill in the art to which the present invention pertains can easily implement the present invention with reference to the accompanying drawings. As can be easily understood by those of ordinary skill in the art to which the present invention pertains, the embodiments described below may be modified in various forms without departing from the spirit and scope of the present invention. Identical or similar parts are denoted by the same reference numerals in the drawings as much as possible.

The technical terms used herein are intended merely to describe a specific embodiment, and is not intended to limit the present invention. As used herein, each singular form also includes a plural form unless the phrases clearly indicate the opposite.

The meaning of ‘including’ used herein specifies one or more specific features, regions, integers, steps, operations, elements and/or components, but does not exclude the presence or addition of another specific feature, region, integer, step, operation, element, component and/or group.

All terms including technical terms and scientific terms used herein have the same meanings as those commonly understood by those of ordinary skill in the art to which the present invention pertains. Terms defined in dictionaries are additionally interpreted as having meanings consistent with those described in the related art literature and the presently disclosed content. Unless defined, they are not to be construed in ideal or considerably formal senses.

Embodiments described herein may have at least one of hardware and software aspects. In this specification, each of a unit, a module, an apparatus, and a system may be a process, an object, an executable file, an executable thread, a program, and/or a computer.

The present invention will be described below with reference to the drawings. For reference, the drawings may be partially exaggerated in order to describe the features of the present invention. In this case, it is preferable to perform interpretation in light of the overall context of this specification.

The present invention is directed to a system that is operated by a program executed by an arithmetic processing means including a computer and that estimates the market price of a target collective house (hereinafter referred to as the ‘target house’) whose market price is to be estimated.

In the present invention, collective housing means the collective housing pursuant to the provision of Paragraph 2 of Article 2 of Korean Public Notice of Values and Appraisal of Real Estate Act, and includes ‘apartment housing,’ ‘tenement housing,’ and ‘multi-household housing’ pursuant to Korean Building Act. Accordingly, according to the present invention, the collective housing may include at least one of apartment housing, tenement housing, and multi-household housing.

A collective housing market price estimation system having a similar complex generation unit according to the present invention includes a database unit 100, a similar complex group generation unit 200, a price information maintenance unit 300, a similar case extraction unit 400, and a final price calculation unit 500.

The database unit 100 according to the present invention may collect and store officially announced price information, market price information, and housing characteristic information.

The similar complex group generation unit 200 according to the present invention may select real estate similar to a target house as a similar complex group by using the housing characteristic information of the database unit 100.

The price information maintenance unit 300 according to the present invention may remove one or more characteristic inconsistency cases and one or more price outlier cases from the information of the database unit 100 regarding the similar complex group selected by the similar complex group generation unit 200.

The similar case extraction unit 400 according to the present invention may extract one or more cases similar to the target house from the similar complex group.

The final price calculation unit 500 according to the present invention may estimate the price of the target house from the similar cases extracted by the similar case extraction unit 400.

First, the database unit 100 according to the present invention will be described.

The database unit 100 according to the present invention includes an officially announced price information collection unit 110, a market price information collection unit 120, and a housing characteristic information collection unit 130.

The officially announced price information collected by the officially announced price information collection unit 110 according to the present invention refers to collective housing officially announced price information.

The officially announced price information refers to the collective housing officially announced price information pursuant to Articles 3 and 4 of Korean Public Notice of Values and Appraisal of Real Estate Acts. The collective housing officially announced price information includes the information that is officially announced after the Korean Minister of Land, Infrastructure and Transport surveys and calculates appropriate prices for collective housing as of the base date (January 1) of official announcement every year and then the Central Real Estate Assessment Commission pursuant to Article 24 of the Korean Public Notice of Values and Appraisal of Real Estate Act reviews the appropriate prices for collective housing.

The officially announced price information is directly used to calculate the realization rate (the ratio of the officially announced price to the fair market price) for each comparative case.

The market price information collected by the market price information collection unit 120 according to the present invention may include at least one of transaction case prices, appraisal case prices, and regional survey case prices.

The transaction cases according to the present invention include the cases disclosed by the Real Estate Transaction Management System (RTMS) of the Korean Ministry of Land, Infrastructure and Transport among the collective housing transaction cases reported pursuant to Article 3 of the Korean Act on Report on Real Estate Transactions, Etc.

The appraisal cases according to the present invention include cases in which collective houses are appraised for pending litigation in court or auction pursuant to Article 10(4) of the Korean Act on Appraisal and Certified Appraisers.

The regional survey cases according to the present invention refer to market price cases for corresponding collective housing that are calculated or verified while specific survey personnel perform official real estate price announcement and statistics-related work. The survey personnel include, e.g., survey personnel of the Korea Appraisal Board or personnel entrusted with survey by the Korea Appraisal Board.

The market price information according to the present invention may be directly used to extract a comparative case for the estimation of the appropriate market price of a target house after the process of removing a characteristic inconsistency case and a price outlier case is performed.

For the description of the collective housing market price estimation system according present invention, the transaction time point of a transaction case, the appraisal time point of an appraisal case, and the survey time point of a regional survey case are collectively referred to as a ‘case time point,’ and the transaction price of a transaction case, the appraisal price of an appraisal case, and the survey price of a regional survey case are collectively referred to as a ‘case price.’

The housing characteristic information collected by the housing characteristic information collection unit 130 according to the present invention includes at least one of location information, complex information, number-of-households information, floor information, exclusive area information, structure information, use approval date information, and land share information.

The above information is used for the purpose of removing a material inconsistency case by comparing and reviewing the basic characteristics of officially announced price information and the basic characteristics of market price information. It may also be used to set up a case extraction area by constructing a similar group based on the number of years for the age of each complex, the number of households, and the distance.

Next, the similar complex group generating unit 200 according to the present invention will be described.

The similar complex group generation unit 200 may select real estate similar to a target house as a similar complex group by using the housing characteristic information of the database unit 100.

The collective housing price estimation system according to the present invention estimates the market price of the target house by selecting and comparing the market price information of the real estate similar to the target house. When dissimilar information is extracted and compared, it is necessary to compensate more for the price difference due to the difference in individual characteristics. The reason for this is that the possibility that an error occurs in the process of identifying and calculating a corresponding correction value increases. Accordingly, the accuracy of the estimated price may be improved only when the similarity of a selected comparative case is improved.

To this end, it is preferable that the similar complex group generation unit 200 selects, as the similar complex group, a complex, whose aging condition, complex size condition, and distance condition satisfy preset ranges based on the complex to which the target house belongs, from the housing characteristic information.

In other words, it is desirable that the similar complex group generation unit selects the complexes that are similar in aging and size to and geographically close to the complex to which the target house belongs as the similar complex group, so that comparative cases are extracted only within the corresponding complex group. Through this, the similarity of comparative cases may be secured. However, it is desirable to use only apartment complexes for an apartment house and only tenement house/multi-household house complexes for a house/multi-household house in the generation of the tenement similar complex group.

In connection with the ‘aging condition’ according to the present invention, it is preferable that the difference in the date of approval for use with respect to the complex to which the target house belongs is equal to or smaller than a preset reference. In other words, the aging is determined based on the date of approval for use for each complex. Accordingly, a ‘complex with a similar degree of aging’ may mean a complex for which the difference in the date of approval for use between itself and the complex to which the target house belongs is equal to or smaller than a specific reference (e.g., ±5 years).

In connection with the ‘complex size condition’ according to the present invention, it is preferable that the difference in the total number of households with respect to the complex to which the target house belongs is equal to or smaller than a preset reference. In other words, the size of a complex refers to the total number of households in the complex. When there are variously sized houses (for example, houses having exclusive areas of 64 m², 85 m², etc.) in each complex, the total number of households corresponding to all the relevant areas bands is measured as the size of the complex. Accordingly, a ‘complex with a similar complex size’ means a complex for which the difference in the number of households between itself and the complex to which the target house belongs is equal to or smaller than a specific reference (e.g., ±200 households).

However, it is considered that the similarity in size is satisfied between large-sized complexes of a specific size or larger. Accordingly, for a complex of a specific size or larger (e.g., a complex having 500 households), a complex equal to or larger than the complex to which the target house belongs by a specific reference (e.g., −200 households) is considered a similar complex. Meanwhile, in the case of a tenement house and a multi-household house, the complex size condition is excluded.

In connection with the ‘distance condition’ according to the present invention, it is preferable that the separation distance from the complex to which the target house belongs is equal to or shorter than a preset reference. In other words, a ‘geographically close complex’ means a complex whose distance from the complex to which the target house belongs is within a specific reference (e.g., 2 km). Meanwhile, in view of the fact that collective housing complexes are relatively rare in a Eup or Myeon area, a ‘complex to which the distance is equal to or shorter than a preset reference’ or a ‘complex belonging to the relevant Eup/Myeon area’ may be considered a geographically close complex.

In the present invention, the complexes that are similar in aging and size to and geographically close to the complex to which the target house belongs become a ‘similar complex group,’ and a similar complex group is used as a basic group to extract comparative cases.

For example, if there are nearby collective housing complexes around a target housing (101-dong 101-ho, Daehan Apartment Complex 1) as shown in Table 1 below, only complexes 2, 3, and 6, including complex 1, which is the complex to which the target house belongs, can be a similar complex group.

Complex 4 is not similar in terms of aging because the date of approval for use thereof differs from that of the target complex by more than 5 years, and complex 5 is not geographically close to the target complex because the distance from the target complex is more than 2 km. Also, cases 7 and 8 are not similar because they differ from the target complex by more than 200 households and are small-sized complexes. Finally, cases 9 and 10 will not be included in the similar complex group because the type of housing is not apartment housing.

In general, a real estate market area is not pre-divided, but may vary depending on the geographic location of a market price estimation target and an area where a substitute is present. The present invention is characterized in that a similar complex group is generated for each target house by taking into consideration this point.

Next, the price information maintenance unit 300 according to the present invention will be described.

The maintenance of price information refers to the maintenance of actual transaction information that does not go through expert verification in market price information and, thus, needs to be reviewed for adequacy. Among transaction cases, there may be cases where the physical characteristics of a report object are incorrectly described, cases where a false declaration is made for tax reduction, and cases where a special circumstance, such as a family transaction, is involved and a price deviates from a normal market price, etc. Accordingly, they require review and maintenance.

In the present invention, through the process of removing one or more physical characteristic inconsistency cases and further removing one or more price outlier cases for the purpose of the maintenance of price information, the adequacy of actual transaction information used without maintenance in the past may be improved, and accurate price estimation may be made.

The price information maintenance unit 300 according to the present invention may include a characteristic inconsistency case removal unit 310 configured to remove case information in which housing characteristic information included in officially announced price information and housing characteristic information included in actual transaction information are different.

Since the material characteristics are main factors influencing the price of the target house and a physical characteristic inconsistency means that any one piece of data of the data used is erroneous, the data cannot be used as appropriate price data, so that it needs to be removed.

The removal of a physical characteristic inconsistency case refers to the step of removing data with different information about a floor, an exclusive area (hereinafter referred to as the ‘area’), a structure, and a date of approval for use included in the officially announced price data and the actual transaction data.

For example, when actual transaction information is as shown in Table 2 below, case 1 is removed because the area of the officially announced price data and the area of the actual transaction data are different. The reason for this is that the difference in the area of the data is larger than a preset reference (e.g., ±0.2 m²). In case 2, although the areas are different, it is considered that there is no difference in area because the difference is smaller than the preset reference. Cases 3 and 4 are determined to be normal cases because all presented physical characteristics are the same. Case 5 is removed because there is a difference in the date of approval for use. When some of the officially announced price data and actual transaction data are as shown in Table 2 below, cases 1 and 5 may be removed as physical characteristic inconsistency cases.

TABLE 2

| | | Officially Announced | | | |
|---|---|---|---|---|---|
| | | Price Data | | Actual Transaction Data | |
| | | Date of | | Date of | |
| | | Approval | | Approval | |
| Identification | | for Use | Area | for Use | Area |
| 1 | 101-dong 101-ho, | Dec. 1, | 84 m2 | Dec. 12, | 88 m2 |
| | Daehan Apartment | 2000 | | 2000 | |
| | Complex | | | | |
| 2 | 201-dong 2001-ho, | May 1, | 84.5 m² | May 1, | 84.4 m² |
| | Daehan Apartment | 2001 | | 2001 | |
| | Complex | | | | |
| 3 | 101-dong 1001-ho, | Jun. 15, | 84 m² | Jun. 15, | 84 m² |
| | Minguk Apartment | 2005 | | 2005 | |
| | Complex | | | | |
| 4 | 110-dong 505-dong, | Jun. 15, | 65 m² | Jun. 15, | 65 m² |
| | Minguk Apartment | 2005 | | 2005 | |
| | Complex | | | | |
| 5 | 201-dong 105-ho, | Feb. 1, | 115 m² | May 1, | 115 m² |
| | Sungwon Apartment | 1998 | | 2008 | |
| | Complex | | | | |

The price information maintenance unit 300 according to the present invention may include a price outlier case removal unit 320 configured to remove case information in which the realization rate, which is the ratio of the officially announced price of collective housing, corrected for the time when an actual transaction is performed by using an apartment housing transaction price index or a tenement/multi-householder housing transaction price index, to the actual transaction price of collective housing, is outside a preset range.

The removal of a price outlier case refers to the process of determining outliers that are difficult to recognize as having been obtained in the normal market such as an excessively low or high price attributable to a special circumstance such as a transaction between family members, a falsely reported transaction price for tax reduction, etc. according to preset criteria and removing the outliers from actual transaction information.

The price outlier case removal unit determines and removes a case where realization rate is extreme or a transaction amount itself is determined to be extreme. To this end, the ratio of the officially announced price of collective housing to the actual transaction price of actual transaction information (hereinafter referred to as the ‘realization rate’) is calculated.

$$Realization Rate = \frac{Temporally - corrected officially announced price}{Actual transaction price}$$

The realization rate is calculated using the officially announced price (hereinafter referred to as the ‘temporally-corrected officially announced price’) of collective housing, corrected for the time when an actual transaction is performed by using the apartment housing transaction price index or the tenement/multi-householder housing transaction price index, and the actual transaction price of collective housing. Thereafter, after the actual transaction data has been classified for each similar complex group, one or more outliers are determined by checking the realization rate distribution of actual transaction data belonging to the same group.

The ‘apartment housing transaction price index’ refers to the index of price fluctuation rate of apartment housing samples among collective houses across the country, which is announced every month pursuant to Article 91 of the enforcement decree of the Korean Housing Act. The apartment housing transaction price index used for temporal correction is selected according to the city/gun/gu to which a corresponding case belongs, and is calculated by multiplying monthly transaction price indices.

The ‘tenement/multi-householder housing transaction price index’ refers to the index of price fluctuation rate of tenement/multi-householder housing samples among collective houses across the country, which is announced every month pursuant to Article 91 of the enforcement decree of the Korean Housing Act. The tenement/multi-householder housing price index used for temporal correction is selected according to the city/gun/gu to which a corresponding case belongs, and is calculated by multiplying monthly transaction price indices.

In the determination of an outlier, the IQR outlier determination technique commonly used to remove statistical outliers is used, and at the same time, a case corresponding to preset outlier criteria (e.g., upper and lower 5%) in the realization rate distribution may be determined to be an outlier and then removed.

In this case, IQR is an abbreviation of InterQuartile Range, and means the difference between the 3rd quartile (Q3) and the 1st quartile (Q1) in statistics. The IQR outlier determination technique refers to a statistical technique that determines value corresponding to a value (smaller than Q1-1.5 IQR) or a value (larger than Q3+1.5 IQR) to be an outlier.

Next, the similar case extraction unit 400 according to the present invention will be described.

The similar case extraction unit 400 may extract a similar case of the target house from the similar complex group.

The similar case extraction unit 400 according to the present invention may include an extraction condition application unit 410 configured to apply the conditions for extracting one or more similar cases from the market price information of the similar complex group, and a priority condition application unit 420 configured to extract one or more cases similar to the target house from the cases, extracted by the extraction condition application unit, by applying priority conditions.

Even in a similar complex group, it is unlikely that there will be a comparative case that has completely similar individual characteristics to those of the target house. In addition, when there is a rapid market change, even a past transaction case with similar individual characteristics may not be an appropriate comparative case. In the present invention, in order to solve this problem, extraction conditions and extraction priority may be set by taking into consideration the area, the case time point, and the like.

The extraction condition application unit 410 according to the present invention may extract one or more similar cases by sequentially applying a first extraction condition for extracting market price information within a preset period, a second extraction condition for extracting information in which the difference in area with respect to the target house is within a preset range, and a third extraction condition for extracting only the latest information when a plurality of pieces of market price information is present for the target house.

In the case of the first extraction condition, market price information for a preset period (e.g., within the last year) may be used to ensure the timeliness of information.

In the case of the second extraction condition, only data in which a difference in area with respect to the target house is, e.g., within ±30% may be used.

In the case of the third extraction condition, where there is a plurality of pieces of market price information for a corresponding collective house, only the latest information may be used. These extraction conditions may vary depending on regional collective housing market situations or macroeconomic changes.

For example, when market price data in the similar complex group is present as shown in Table 3 below, cases 2, 4, and 9 do not meet the extraction conditions and are excluded from the extraction of comparative cases. Case 2 is excluded from the extraction because the area thereof differs from that of the target house by more than 30%. Case 4 is excluded from the extraction because there is the latest transaction case for the corresponding collective house. Case 9 is excluded from the extraction because the time point of the case (May 1, 19) has elapsed compared to the reference time point (Jul. 20, 20) by more than one year. Other cases may be extracted because they meet the conditions.

The priority condition application unit 420 according to the present invention may extract one or more similar cases by sequentially applying a first priority condition for extracting a case of the same complex in preference to a case of a similar complex, a second priority condition for preferentially extracting a case whose case time point is within a preset period from a reference time point, and a third priority condition for preferentially extracting cases in the sequence of a case of the same area, a case of the same pyeong type, and a case of a similar area.

It is necessary to set priority for a case that is preferentially extracted from among cases in a similar complex group that meet the extraction conditions.

In the present invention, a case of the same complex is extracted in preference to a case of a similar complex according to the first priority condition. According to the second priority condition, a case whose case time point is within six months from a reference time point is preferentially extracted.

According to the third priority condition, cases are preferentially extracted in the sequence of a case of the same area, a case of the same pyeong type, and a case of a similar area.

In this case, the ‘case of the same area’ refers to a case that has the same area and structure as the target house. The ‘case of the same pyeong type’ refers to a case that is not a case of the same area, but has an area difference of 3.3 m² or smaller with respect to the target house. The ‘case of a similar area’ refers to a case that has an area difference larger than 3.3 m² and smaller than 30% with respect to the target house.

If cases are all the same in terms of the first, second, and third priority conditions, a case having a case time point closer to the reference time point is preferentially extracted.

For example, in Table 4 below that are obtained by rearranging the cases in Table 3, cases 1, 3, 5, 6, 7, 8, and 10 meet the extraction conditions. Among them, cases 1 and 3, which are cases of the same complex, may be extracted in preference to cases 5, 6, 7, 8, and 10, which are cases of a similar complex.

Between cases 1 and 3, case 1, which is a case within six months, may be extracted in preference to case 3.

Among cases 5, 6, 7, 8, and 10, cases 7 and 8, which are cases within six months, may be extracted in preference to cases 5, 6, and 10.

Between cases 7 and 8, case 7, which is of the same pyeong type, may be extracted in preference to case 8, which is a case of a similar area.

Meanwhile, among cases 5, 6, and 10, case 5, which is a case of the same area (assuming that this case has the same structure), may be extracted most preferentially.

When the number of extracted cases reaches a preset number (e.g., 5 cases), the extraction is terminated. In the present example, five cases are extracted in the sequence of cases 1, 3, 7, 8, and 5.

The present invention includes a final price calculation unit 500 configured to estimate the price of the target house from the similar cases extracted by the similar case extraction unit 400.

The final price calculation unit 500 according to the present invention includes a average per-complex realization rate calculation unit 510 configured to calculate the average realization rate of each complex by obtaining the arithmetic average of the realization rates of the extracted case prices for each complex.

The per-complex average realization rate calculation unit 510 constructs the average realization rate of each complex by obtaining the arithmetic average of the realization rates of the extracted cases for each complex. The constructed average realization rate is used to correct the difference in the realization rate for each complex. The reason for this is to solve the problem in which a relatively low market price estimate is obtained when a case of a complex with a high realization rate is used.

For example, as shown in Table 5 below, when the arithmetic average of the realization rates of cases 1 and 3, which are transaction cases of Daehan Apartment Complex 1, is obtained, the arithmetic average is calculated as 67.2%. In the same way, the arithmetic average of the realization rates for Daehan Apartment Complex 2 is calculated as 65.9%. Meanwhile, the arithmetic average of the realization rates for Minguk Apartment Complex 1 is calculated at 72.9%.

The constructed average realization rate for each complex is used to correct a trial price for each case, calculated by the per-case trial price calculation unit 520, in the price determination unit 530. A detailed process will be described in the section related to the price determination unit 530.

The final price calculation unit 500 according to the present invention includes a per-case trial price calculation unit 520 configured to calculate a trial price for each case by dividing the realization rate by the officially announced price of the target house.

The per-case trial price calculation unit 520 calculates a realization rate by comparing the extracted case price with the temporally-corrected officially announced price, and then calculates a trial price for each case by dividing the realization rate by the officially announced price of the target house.

In this case, the ‘realization rate’ means the ratio of the temporally-corrected officially announced price to the case price. The temporally-corrected officially announced price is a value obtained by multiplying a price, officially announced most recently based on a case time point, by the apartment housing transaction price index or the tenement/multi-householder housing transaction price index from the date on which the officially announced price is announced (e.g., January 1) to the case time.

On the assumption that the realization rate of the target house is similar to the realization rate of an extracted case, the appropriate market price of the target house may be estimated by dividing the officially announced price of the target house by the realization rate for each case. This estimated price is referred to as the ‘per-case trial price.’ For example, when the temporally-corrected officially announced price (117,000,000 won) of the target house is divided by the realization rate (0.656) of case 1, the per-case trial price (178,354,000 won) is calculated (see Table 6).

The final price calculation unit 500 according to the present invention includes a price determination unit 530 configured to calculate a realization rate correction value by using the difference between the average realization rate of the complex to which the target house belongs and the average realization rate of a similar complex before calculating a final price.

When the difference in average realization rate is equal to or smaller than a preset reference, the price determination unit 530 may calculate the realization rate correction value as 1.000.

When the difference in average realization rate exceeds the preset reference, the price determination unit 530 may calculate the realization rate correction value by the following equation:

$$Realization rate correction value = \frac{Average realization rate of target complex}{Average realization rate of similar complex}$$

A more detailed description thereof is as follows.

The price determination unit 530 calculates a realization rate correction value by using a calculated average realization rate for each complex before calculating a final price.

First, when the difference between the average realization rate of the complex to which the target house belongs and the average realization rate of a similar complex is equal to or smaller than a preset reference (e.g., 3% p), a realization rate correction value is calculated as 1.000. In the above case, the difference between the average realization rates of Daehan Apartment Complexes 1 and 2 is 1.3% p (=|67.2%−65.9%|), so that it is considered that there is no significant difference, and thus a realization rate correction value is calculated as 1.000.

In contrast, when the difference in average realization rate exceeds a preset reference, the ‘average realization rate of the target complex: the average realization rate of a similar complex’ is used as the realization rate correction value. For example, Minguk Apartment Complex 1 has an average realization rate higher than that of Daehan Apartment Complex 1 by 5.7% p (=|67.2%−72.9%|). In this case, there is a problem that the trial price calculated by dividing the realization rate for each case of Minguk Apartment Complex 1 is lower than that in the case of Daehan Apartment Complex 1. Since in order to solve this problem, the realization rate is calculated to be high by applying a realization rate correction value of 0.922 (=67.2%/72.9%), the part where the per-case trial price is calculated to be low needs to be corrected (see Table 7).

The price determination unit 530 according to the present invention may calculate a final trial price by weighting per-case trial prices with the reciprocal of the distance to the target complex and averaging them.

In the above example, since there are five extracted cases, five per-case trial prices (the prices obtained by dividing the temporally-corrected officially announced price of the target house by a corrected realization rate) are calculated. The five per-case trial prices are weighted by the reciprocal of the distance to the target complex and then averaged (hereinafter referred to as the ‘distance-weighted average’). This is performed through the following equation:

$$Final Trial Price = \frac{\frac{1}{d i s {t}_{1}} \times {price}_{1} + … + \frac{1}{d i s {t}_{5}} \times {price}_{5}}{\frac{1}{d i s {t}_{1}} + … + \frac{1}{d i s {t}_{5}}} \times temporal correction value$$

where dist₁ and dist₅ are the straight-line distances between the target complex and cases 1 and 5, and price₁ and price₅ are the ‘per-case trial prices’ of cases 1 and 5.) The price calculated through this distance-weighted average is 174,224,000 won in the above example.

The final price calculation unit 500 according to the present invention includes a confidence rating unit 540 configured to assign a confidence level of any one of good, normal, and insufficient when the number of cases finally extracted is within a preset range.

When the number of per-case trial prices to which the realization rate correction value is applied is equal to or larger than a preset number, the confidence rating unit 540 may assign a confidence level lower than a reference level by one level.

For example, the confidence level ‘good’ is assigned when the number of finally extracted cases is five, the confidence level ‘normal’ is assigned when the number of finally extracted cases is three or more and four or less, the confidence level ‘insufficient’ is assigned when the number of finally extracted cases is two or less, and a confidence level is not calculated when the number of finally extracted cases is zero.

If the number of per-case trial prices to which the realization rate correction value is applied is equal to or larger than a preset number (e.g., three), the price determination unit 530 may downgrade the confidential level.

Meanwhile, the present invention may be implemented as a method that is configured in the form of a program executed by an arithmetic processing means including a computer and estimates the market price of a target house. In the present invention, although the collective housing market price estimation method is different from the collective housing market price estimation system in terms of the category of the invention, they share the essential operating principle and components of the invention. Accordingly, overlapping portions will be excluded, and the following description will be given with a focus on the gist of the method.

A collective housing market price estimation method having a similar complex group generation unit according to the present invention may include: step S1 of collecting and storing, by the database unit 100, officially announced price information, market price information, and housing characteristic information; step S2 of selecting, by the similar complex group generation unit 200, real estate similar to a target house as a similar complex group by using the housing characteristic information of the database unit 100; step S3 of removing, by the price information maintenance unit 300, a characteristic inconsistency case and a price outlier case from information of the database unit 100 regarding the similar complex group selected by the similar complex group generation unit 200; step S4 of extracting, by the similar case extraction unit 400, one or more cases similar to the target house from the similar complex group; and step S5 of estimating, by the final price calculation unit 500, the price of the target house from the similar cases extracted by the similar case extraction unit.

Meanwhile, the present invention may be implemented in the form of a computer program. The present invention may be implemented as a computer program stored in a computer-readable storage medium in order to perform the collective housing market price estimation method having a similar case extraction unit according to the present invention in combination with hardware for processing information via software on a computer.

The operations performed in the present invention may be performed within digital electronic circuitry, computer hardware, firmware, or combinations thereof. Features may be performed in a computer program product implemented in a storage device in a machine readable storage device, for example, for execution by a programmable processor. Furthermore, features may be performed by a programmable processor executing a program of instructions for performing the functions of the described embodiments through operation on input data and the generation of output. The described features may be performed on a programmable system including at least one programmable processor, at least one input device, and at least one output device that are coupled to receive data and instructions from a data storage system and to transmit data and instructions to the data storage system.

The embodiments described herein and the accompanying drawings are merely illustrative of some of the technical spirit included in the present invention. Accordingly, the embodiments disclosed herein are not intended to limit the technical spirit of the present invention, but are intended to describe the technical spirit of the present invention. It will be apparent that the scope of the technical spirit of the present invention is not limited by these embodiments. All modifications and specific embodiments that may be easily inferred within the scope of the technical spirit included in the specification and accompanying drawings of the present invention by those skilled in the art should be interpreted as being included in the scope of the present invention.

1. A collective housing market price estimation system having a similar complex group generation unit, the collective housing market price estimation system being operated by a program executed by an arithmetic processing means including a computer and estimating a market price of collective housing, the collective housing market price estimation system comprising:
a database unit configured to collect and store officially announced price information, market price information, and housing characteristic information;
a similar complex group generation unit configured to select real estate similar to a target house as a similar complex group by using the housing characteristic information of the database unit;
a price information maintenance unit configured to remove a characteristic inconsistency case and a price outlier case from information of the database unit regarding the similar complex group selected by the similar complex group generation unit;
a similar case extraction unit configured to extract one or more cases similar to the target house from the similar complex group; and
a final price calculation unit configured to estimate a price of the target house from the similar cases extracted by the similar case extraction unit.

2. The collective housing market price estimation system of claim 1, wherein the collective housing includes at least one of apartment housing, tenement housing, and multi-household housing.

3. The collective housing market price estimation system of claim 1, wherein the market price information of the database unit includes at least one of transaction case prices, appraisal case prices, and regional survey case prices.

4. The collective housing market price estimation system of claim 1, wherein the housing characteristic information of the database unit includes at least one of location information, complex information, number-of-households information, floor information, exclusive area information, structure information, date-of-approval-for-use information, and land share information.

5. The collective housing market price estimation system of claim 1, wherein the similar complex group generation unit selects, as the similar complex group, a complex, whose aging condition, complex size condition, and distance condition satisfy preset ranges with respect to a complex to which the target house belongs, from the housing characteristic information.

6. The collective housing market price estimation system of claim 5, wherein the aging condition is that a difference in a date of approval for use with respect to the complex to which the target house belongs is equal to or smaller than a preset reference.

7. The collective housing market price estimation system of claim 5, wherein the complex size condition is that a difference in a total number of households with respect to the complex to which the target house belongs is equal to or smaller than a preset reference.

8. The collective housing market price estimation system of claim 5, wherein the distance condition is that a separation distance from the complex to which the target house belongs is equal to or shorter than a preset reference.

9. The collective housing market price estimation system of claim 1, wherein the price information maintenance unit includes a characteristic inconsistency case removal unit configured to remove a case in which officially announced price information and housing characteristic information are different.

10. The collective housing market price estimation system of claim 1, wherein the price information maintenance unit includes a price outlier case removal unit configured to remove case information in which a realization rate, which is a ratio of an officially announced price of collective housing, corrected for a time when an actual transaction is performed by using an apartment housing transaction price index or a tenement/multi-householder housing transaction price index, to an actual transaction price of the collective housing, is outside a preset range:
$$Realization Rate = \frac{Temporally - corrected officially announced price}{Actual transaction price}$$

11. The collective housing market price estimation system of claim 1, wherein the similar case extraction unit includes an extraction condition application unit configured to apply conditions for extracting the similar cases from market price information of the similar complex group, and a priority condition application unit configured to extract one or more cases similar to the target house from the cases, extracted by the extraction condition application unit, by applying priority conditions.

12. The collective housing market price estimation system of claim 11, wherein the extraction condition application unit extracts the one or more similar cases by sequentially applying:
a first extraction condition for extracting market price information within a preset period;
a second extraction condition for extracting information in which a difference in area with respect to the target house is within a preset range; and
a third extraction condition for extracting only latest information when a plurality of pieces of market price information is present for the target house.

13. The collective housing market price estimation system of claim 11, wherein the priority condition application unit extracts the one or more similar cases by sequentially applying:
a first priority condition for extracting a case of a same complex in preference to a case of a similar complex;
a second priority condition for preferentially extracting a case whose case time point is within a preset period from a reference time point; and
a third priority condition for preferentially extracting cases in a sequence of a case of a same area, a case of a same pyeong type, and a case of a similar area.

14. The collective housing market price estimation system of claim 1, wherein the final price calculation unit comprises a per-complex average realization rate calculation unit configured to calculate an average realization rate of each complex by obtaining an arithmetic average of realization rates of extracted case prices for each complex.

15. The collective housing market price estimation system of claim 14, wherein the final price calculation unit includes a per-case trial price calculation unit configured to calculate a trial price for each case by dividing a corresponding realization rate by an officially announced price of the target house.

16. The collective housing market price estimation system of claim 15, wherein the final price calculation includes a price determination unit configured to calculate a realization rate correction value by using a difference between an average realization rate of a complex to which the target house belongs and an average realization rate of a similar complex before calculating a final price.

17. The collective housing market price estimation system of claim 16, wherein the price determination unit calculates the realization rate correction value as 1.000 when the difference between the average realization rates is equal to or smaller than a preset reference.

18. The collective housing market price estimation system of claim 16, wherein the price determination unit calculates the realization rate correction value by the following equation:
$$Realization rate correction value = \frac{Average realization rate of target complex}{Average realization rate of similar complex}$$
when the difference between the average realization rates exceeds the preset reference.

19. The collective housing market price estimation system of claim 16, wherein the price determination unit calculates a final trial price by weighting per-case trial prices with a reciprocal of a distance to the target complex and then averaging them through the following equation:
$$Final Trial Price = \frac{\frac{1}{d i s {t}_{1}} \times {price}_{1} + … + \frac{1}{d i s {t}_{5}} \times {price}_{5}}{\frac{1}{d i s {t}_{1}} + … + \frac{1}{d i s {t}_{5}}} \times temporal correction value$$
(where dist₁ and dist₅ are the straight-line distances between the target complex and cases 1 and 5, and price₁ and price₅ are ‘per-case trial prices’ of cases 1 and 5).

20. The collective housing market price estimation system of claim 18, wherein the final price calculation unit includes a confidence rating unit configured to assign a confidence level of any one of good, normal, and insufficient when a number of cases finally extracted is within a preset range.

21. The collective housing market price estimation system of claim 20, wherein the confidence rating unit assigns a confidence level lower than a reference level by one level when a number of per-case trial prices to which the realization rate correction value is applied is equal to or larger than a preset number.

22. A collective housing market price estimation method having a similar complex group generation unit, the collective housing market price estimation method being configured in a form of a program executed by an arithmetic processing means including a computer and estimating a market price of collective housing, the collective housing market price estimation method comprising:
step S1 of collecting and storing, by a database unit, officially announced price information, market price information, and housing characteristic information;
step S2 of selecting, by a similar complex group generation unit, real estate similar to a target house as a similar complex group by using the housing characteristic information of the database unit;
step S3 of removing, by a price information maintenance unit, a characteristic inconsistency case and a price outlier case from information of the database unit regarding the similar complex group selected by the similar complex group generation unit;
step S4 of extracting, by a similar case extraction unit, one or more cases similar to the target house from the similar complex group; and
step S5 of estimating, by a final price calculation unit, a price of the target house from the similar cases extracted by the similar case extraction unit.

23. A computer program stored in a computer-readable recording medium in order to perform the collective housing market price estimation method having a similar complex group generation unit according to claim 22 in combination with hardware for processing information via software on a computer.
